(19) United States
(12) Patent Application Publication
(10) Pub. No.: US 2015/0339758 A1
(43) Pub. Date: Nov. 26, 2015

(54) COMBINED CONSUMER TARGETED INFORMATION AND POINT OF SALE SYSTEM

(71) Applicant: iZipline LLC, Sarasota, FL (US)

(72) Inventors: Michelle A. Moulin, Sarasota, FL (US); Troy Pittman, Sarasota, FL (US); Keoki Trask, Sarasota, FL (US)

(21) Appl. No.: 14/721,568

(22) Filed: May 26, 2015

Related U.S. Application Data
(60) Provisional application No. 62/002,557, filed on May 23, 2014.

(51) Int. Cl. G06Q 30/06; G06Q 20/20; G06Q 20/32; G06Q 30/02

(52) U.S. Cl. CPC G06Q 30/0631; G06Q 30/0255; G06Q 30/0267; G06Q 30/0268; G06Q 20/20; G06Q 20/322; G06Q 20/3278

(57) ABSTRACT

A combination mobile payment-information delivery system. The system can include a point of sale (POS) device having a mobile payment chip and antenna. The POS device can also have a first near field communication (NFC) device. The POS device with the mobile payment chip and antenna is operable as a mobile payment portal. In addition, the POS device with the first near field communication (NFC) device is operable as a consumer/end-user targeted information (CTI) portal. In this manner, the use of NFC technology for delivering in real-time consumer/end-user targeted information (CTI) is combined with POS devices that can execute mobile payment transactions.

### CROSS-REFERENCE TO RELATED APPLICATION

The instant application claims priority to U.S. Provisional Patent Application No. 62/002,557 filed on May 23, 2014, which is incorporated in its entirety herein by reference.

### FIELD OF THE INVENTION

The instant invention is directed to a combined consumer engagement point-mobile payment method and in particular to a modified mobile payment method that includes a near field communication tag residing within a point of sale system for the purpose of communicating data and information between the point of sale system and a portable electronic device.

### BACKGROUND OF THE INVENTION

The use of dynamic digital data, images, content, etc., for providing information to individuals is known. For example, airports, train stations, malls and the like use large digital displays to provide advertisements, news and the like to people traveling, shopping, etc. In addition, such displays typically have changing content, i.e. an image, video clip, etc., that is displayed for a given amount of time before different content is displayed for viewing. However, it is appreciated that such “dynamic content” is generally non-interactive, i.e. heretofore dynamic content systems do not provide or allow for the possibility of providing additional information on current displayed content in real time.

In addition to the above, the use of contactless payment systems is also known. Such systems wirelessly communicate consumer purchasing information such as credit card information, debit card information and the like to a point of sale system.

Heretofore known dynamic content systems and contactless payment systems have operated or functioned independently of each other. For example, in the retail-products environment the use of a portable electronic device (“PED”) to communicate a payment means/method/source to a retail vendor's point of sale system (hereafter referred to as a “Mobile Payment Method”) is known. Mobile Payment Methods basically consist of a contactless data-exchange system and process performed by and between a PED and point of sale system (“POS”). Also, current contactless data exchange systems such as Bluetooth and NFC (“Near Field Communication”) are employed as single type of communication facilitator, e.g. an NFC-to-PED consumer engagement point or a PED-to-POS payment processing system. Stated differently, prior art systems use one system for displaying dynamic content and a separate system for POS.

Given the above, a combined consumer engagement point-Mobile Payment Method system would be desirable.

### SUMMARY OF THE INVENTION

A combination mobile payment-information delivery system is provided. The system can include a point of sale (POS) device having a mobile payment chip and antenna. The POS device can also have a first near field communication (NFC) device. The POS device with the mobile payment chip and antenna is operable as a mobile payment portal. In addition, the POS device with the first near field communication (NFC) device is operable as a consumer/end-user targeted information (CTI) portal. In this manner, the use of NFC technology for delivering in real-time consumer/end-user targeted information (CTI) is combined with POS devices that can execute mobile payment transactions.

A portable electronic device (PED) having a second NFC device can be part of the system. The PED is operable to make a mobile payment with or to the POS device when it is operable as a mobile payment portal and receive CTI via or through the PUS device when it is operable as said CTI portal. A CTI source can also be included or be part of or included with the POS device, be part of or stored within a local network system and/or be part of or stored in cloud-based network system.

The mobile payment-information delivery system can include a switch that is configured to change the POS device from operating as the mobile payment portal to the CTI portal and vice versa. The switch can be activated either manually or through software interaction. Finally, the switch can include or be part of the POS device, the local network system and/or the cloud-based network system.

A process for making a mobile payment and receiving information with a single POS device is also provided. The process includes providing a mobile payment-information delivery system, for example as discussed above, and purchasing a selected item with the PED and at the POS device via a mobile payment method. Naturally, the POS device operates as the mobile payment portal during the purchase of the selected item. After purchasing of the item is completed, the POS device is switched to operate as the CTI portal and CTI is delivered to the PED. It is appreciated that the CTI can be related to the purchased item and can lead to additional items being purchased at the POS device.

### BRIEF DESCRIPTION OF THE DRAWINGS

FIG. 1 is schematic diagram of a mobile payment-information delivery system according to an embodiment disclosed herein illustrating a single-engagement, single-toggle deployment with intelligent switching selection occurring once during a user's session;

FIG. 2 is schematic diagram of a mobile payment-information delivery system according to an embodiment disclosed herein illustrating a single-engagement, multi-toggle deployment with intelligent switching selection occurring multiple times during a user's session;

FIG. 3 is schematic diagram of a mobile payment-information delivery system according to an embodiment disclosed herein illustrating a multi-engagement, multi-toggle deployment where intelligent switching selection occurs once at the beginning of the user's session;

FIG. 4 is schematic diagram of a mobile payment-information delivery system according to an embodiment disclosed herein illustrating a multi-engagement, multi-toggle deployment where intelligent switching selection occurs once towards the middle or end of the user's session;

FIG. 5 is schematic diagram of a mobile payment-information delivery system according to an embodiment disclosed herein illustrating a multi-engagement, multi-toggle deployment where mode switching occurs without requesting preferred intelligence selection during a user's session;

FIG. 6 is a schematic illustration of a point of sale (POS) device;

FIG. 7 is a schematic illustration of a mode switching design;

FIG. 8 is a schematic illustration of a PED; and

FIG. 9 is s schematic illustration of a process disclosed herein.

### DETAILED DESCRIPTION OF THE INVENTION

In the present invention, a Mobile Payment Method is modified to include a near field communication (“NFC”) tag residing within the POS for the purpose of communicating data and information—i.e. of consumer/end-user targeted information (“CTI”)—between the POS and a PED. The CTI can be retail product information and/or product/service vendor specific information and/or other media content of interest. It is appreciated that the incorporation of NFC technology for the purpose of consumer/end-user targeted information has not heretofore existed within the Mobile Payment Method.

In one embodiment of the invention, an inventive system and/or process employs duplicity of the POS system as a payment portal for Mobile Payment Methods and facilitating the POS-to-PED as a CTI delivery portal through a controlled activation of data exchange flow. For example, the functionality of the POS system can be by activated or toggled between Mobile Payments and CTI delivered to a PED via a contactless data exchange protocol, e.g. using NFC technology. Also, the system affords for this switching/toggling at defined and desired times or based upon/triggered by data received during either a Mobile Payment state or a CTI state. In addition, the switching/toggling can occur manually by consumer/end-user selection or through means of software interaction. Finally, the data management or interpretation can occur within the POS system itself as local intelligence, externally via local network system, and/or a remote cloud based management system.

As stated above, contactless data exchange systems such as NFC (“Near Field Communication”) are employed as one communication facilitator (such as NFC-to-PED consumer engagement points) or another (such as PED-to-POS payment processing systems). However, the instant invention combines these two otherwise singular uses into one controllable or condition-based, intelligent solution. For example, a preferred embodiment of the invention employs a conditional switch between these two independent communication protocols. The invention can include integrated software and/or hardware elements, and can also include secure elements, unsecure elements or a combination of both in order to properly and seamlessly complete desired transactions containing direct delivery of public information and/or the secure handling of private data.

Through the use of a PED in conjunction and inventive contactless data exchange engagement point technology, the system adapts to the needs of the vendor and/or user based upon: (1) certain conditions found in the environment in which the mechanism is placed; (2) a stage of user engagement (such as post payment processing leading into secondary offering calls to action); (3) users' responses during the process; and/or (4) the interaction of such interpretable data, and the like.

In some instances, the system layers a traditional contactless data exchange transmitter within an active, irradiated field of a power-amplified, contactless data exchange receiver. As the PUS reader is made inactive (by means of power switching, by data switching or frequency modification), the otherwise unreadable contactless data exchange transmitter becomes the more interpretable transducer within the two fields' range and by default the new communication tool (NFC-to-PED data exchange). When the POS reader is made active again, it then renders the previous contactless data exchange transmitter either unreadable or significantly unreadable enough for the POS reader to become the preferred communication exchange protocol once more (PED-to-POS data exchange).

It is appreciated that the current competing nature of the above mentioned established, yet independent protocols creates a technology gap that, to date, allows for only one technology or the other to exist within a given space. However, the inventive contactless data exchange mechanism disclosed herein—made intelligent by manual or condition-based switching—allows for one consumer engagement mechanism to contain two competing communication protocols by means of intelligent trafficking of their signals. As such, an industry-wide reduction of manufacturing cost and real-time adaptation to the environment's needs for best consumer engagement is provided.

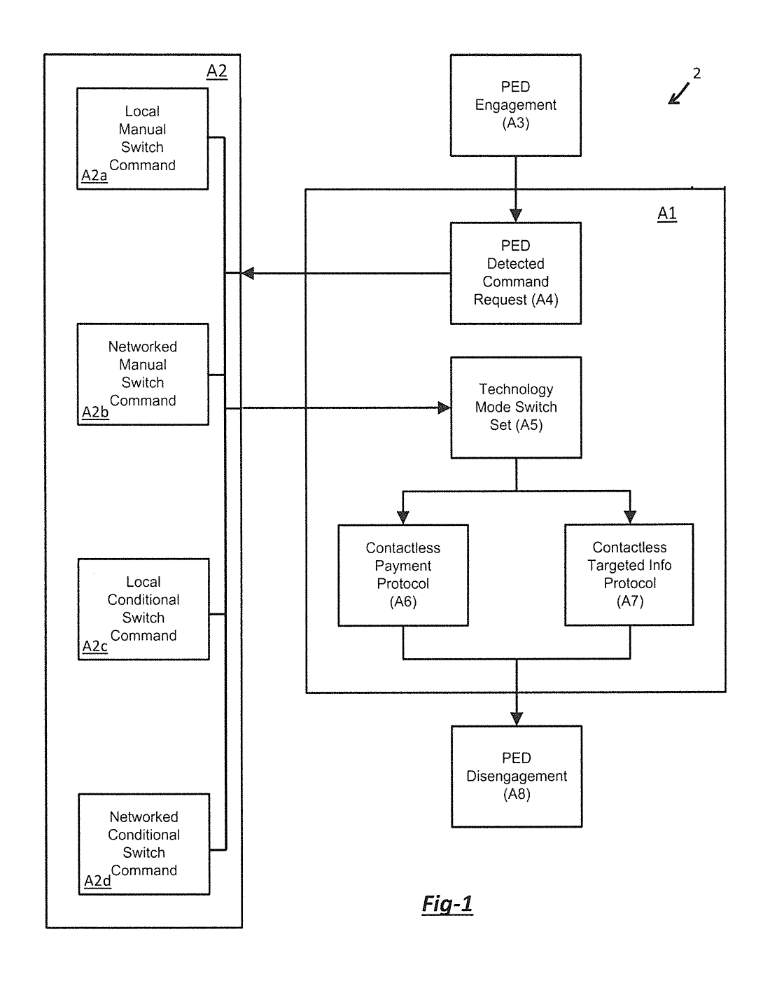

Turning now to FIG. 1, an embodiment of a mobile payment-information delivery system and process with a single-engagement, single-toggle deployment with intelligent switching selection occurring once during a user's session is shown generally at reference numeral 2. The embodiment 2 is considered “one user interaction session achieved over one physical engagement” where the PED does not disengage from the POS during the transaction and where the PED used is the same device throughout the session. In this use, the system is switched between one contactless protocol mode or another per user engagement as desired by the preferred intelligence selection. Where one user has one contactless protocol experience, another user may have the same or different contactless protocol experience depending upon local or remote intelligence driving the switch. Switch mode A might be a contactless payment protocol wherein the POS acts as a payment gateway and switch mode B might be a contactless targeted info protocol wherein the POS acts as a distributor of information.

The system or embodiment 2 includes the POS in a ready state A1 that is dependent upon the preferred intelligence A2 for the initial mode. In addition, the illustrative examples of preferred intelligence that may be used to control the switch's initial mode can include a local manual switch command A2a, a networked manual switch command A2b, a local conditional switch command A2c and/or a networked conditional switch command A2d. At A3, a PED engages with the POS and triggers initial action from the POS, followed by the POS requesting a mode from the preferred intelligence at A4. The desired mode is selected at preferred intelligence A2 and delivered to a POS mode switch at A5. The mode switch then directs the POS into a desired mode (mobile/contactless payment portal or CTI portal) which in turn engages and interacts with the PED in this manner. Box A6 represents a contactless payment protocol has been selected by the preferred intelligence whereas Box A7 represents a contactless CTI protocol has been selected. Finally, the PED is disengaged at A8 after completion of a payment transaction or CTI delivery to the PED.

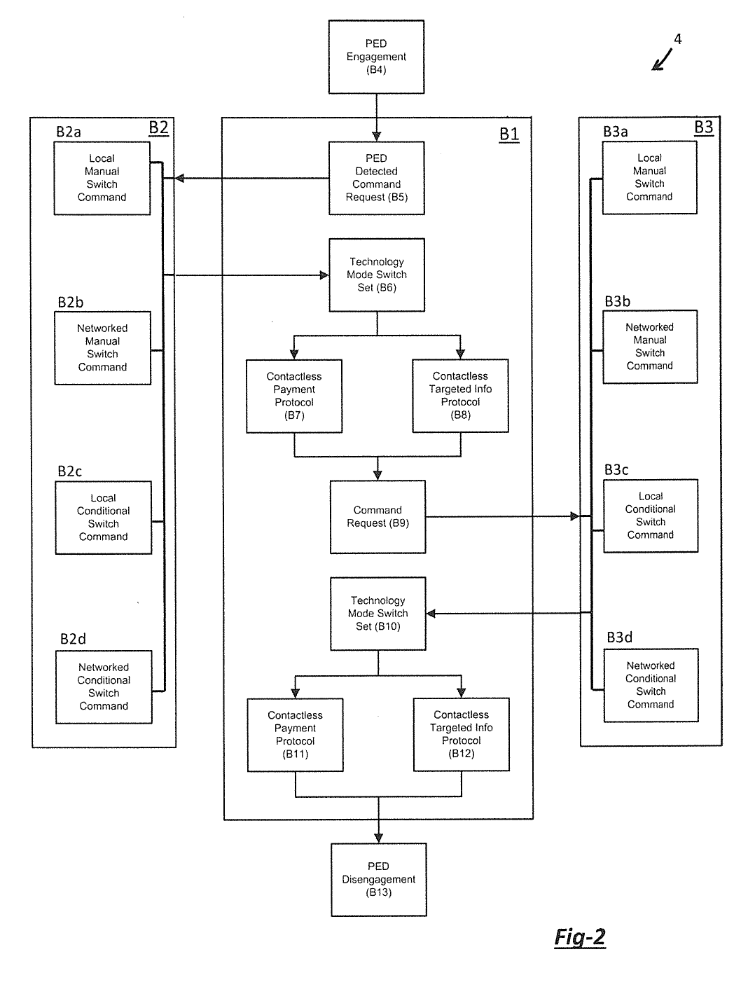

Turning now to FIG. 2, an embodiment of a mobile payment-information delivery system with a single-engagement, multi-toggle deployment with intelligent switching selection occurring multiple times during a user's session is shown at reference numeral 4. The embodiment 4 is considered a “one user interaction session achieved over one physical engagement” where the PED does not disengage from the POS between mode switchings and where the PED used is the same device throughout the session. In this use, the system is switched between one contactless protocol mode or another then again in subsequent transactions for as many cycles as desired by deployment design or the preferred intelligence selection but all within one user engagement wherein the PED does not disengage from the POS between mode switchings. Where one user has one initial contactless protocol experience, another user may have the same or different contactless protocol experience depending upon local or remote intelligence driving the switch. Switch mode A might be a contactless payment protocol wherein the POS acts as a payment gateway and switch mode B might be a contactless targeted info protocol wherein the POS acts as a distributor of information.

The embodiment or system 4 includes the POS in a ready state, dependent upon the preferred intelligence for the initial mode, at B1. Box B2 illustrates examples of preferred intelligence that may be used to control the switch's initial or first mode and Box B3 shows examples of preferred intelligence that may be used to control the switch's later or second mode. Similar to FIG. 1, preferred intelligence B2, B3 can include a local manual switch command B2a, B3a; a networked manual switch command B2b, B3b; a local conditional switch command B2c, B3C; and/or a networked conditional switch command B2d, B3d. At B4, a PED engages with a POS and triggers an initial action from the POS, followed by the POS requesting a mode from the preferred intelligence for an initial mode at B5. Box B6 shows a mode switch that can be set by the preferred intelligence B2 and where one mode or another is selected. Box B7 represents a contactless payment protocol that has been selected by the preferred intelligence whereas Box B8 represents a contactless CTI protocol.

Box B9 illustrates the POS requesting a mode from preferred intelligence for a follow-up mode. Similar to Box B6, Box B10 illustrates a mode switch that can be set by the preferred intelligence B3 and where one mode or another is selected. Box B11 represents a contactless payment protocol that has been selected by the preferred intelligence whereas Box B12 represents a contactless CTI protocol. Finally, the PED is disengaged at B13 after completing one or more payment transactions or CTI deliveries to the PED.

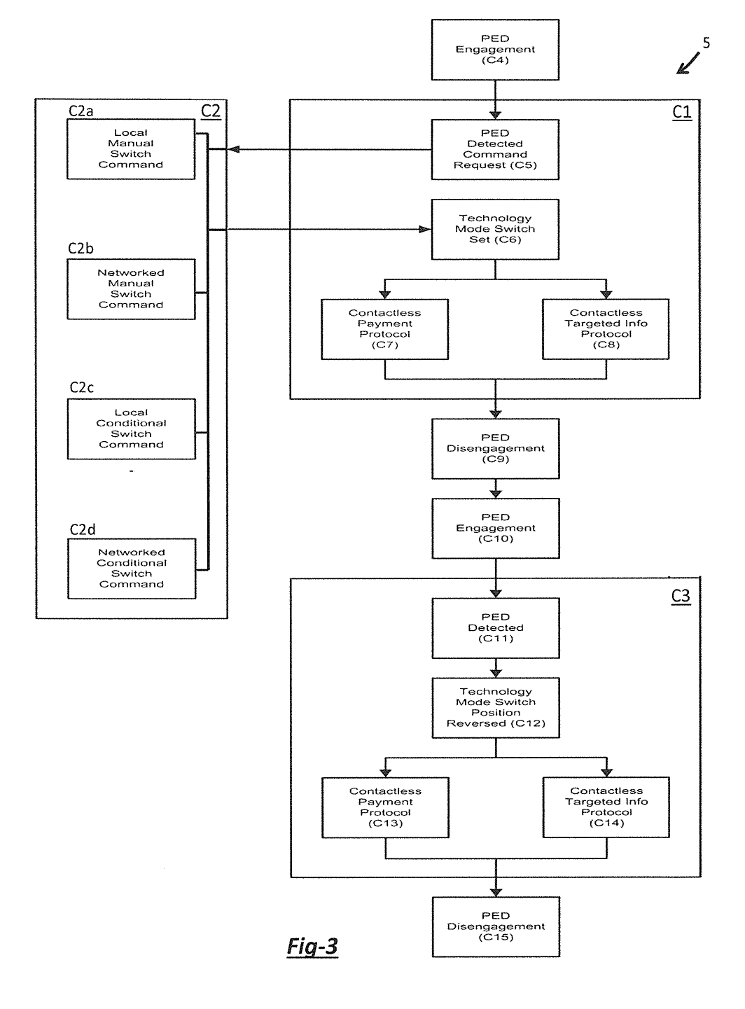

FIG. 3 illustrates an embodiment of a multi-engagement, multi-toggle deployment where intelligent switching selection occurs once at the beginning of the user's session at reference numeral 5. The embodiment 5 is considered “one user interaction session achieved over multiple physical engagements” where the PED does disengage from the POS between mode switchings and where the PED used is the same device throughout the session. In this use, the system is switched between one contactless protocol mode or another for the initial user engagement as desired by deployment design or the preferred intelligence selection. After the initial transaction is completed and when the PED is disengaged from the POS, the POS mode switch reverses position automatically and without requesting a preferred intelligence selection, thus facilitating the opposite mode selection's role either once or for as many cycles as desired by deployment design or the preferred intelligence selection. Where one user has one initial contactless protocol experience, another user may have the same or different contactless protocol experience depending upon local or remote intelligence driving the switch. Switch mode A might be a contactless payment protocol wherein the POS acts as a payment gateway and switch mode B might be a contactless targeted info protocol wherein the POS acts as a distributor of information.

The system or embodiment 5 includes the POS in a ready state C1 that is dependent upon the preferred intelligence for the initial mode. Illustrative examples of preferred intelligence that may be used to control an initial mode of the system is shown at C2 and Box C3 shows the POS in a later ready state after successfully fulfilling its role during the initial mode. The preferred intelligence C2 can include a local manual switch command C2a, a networked manual switch command C2b, a local conditional switch command C2c and/or a networked conditional switch command C2d. Regarding the initial mode, a PED engages with the POS at C4 and triggers an initial action from the POS, followed by the POS requesting a mode from the preferred intelligence at C5. Box C6 refers to a mode switch, the mode switch having been set by the preferred intelligence where one mode or another (mobile payment portal or CTI portal) is selected. Box C7 represents a contactless payment protocol that has been selected by the preferred intelligence whereas Box C8 represents a contactless CTI protocol.

The PED disengages at C9 and then re-engages at C10, for example after a call-to-action. Point C11 shows the PED engaging with the POS again, which in turn triggers follow-up action from the POS. In contrast to C1, the POS does not request a mode from the preferred intelligence, but instead mode switch C12 selects the mode that was not selected initially, i.e. mode switch C12 selects a reverse position or state. Boxes C13 and C14 refer to the selected reverse state being the contactless targeted info protocol and CTI protocol, respectively. Finally, the PED is disengaged again at C15.

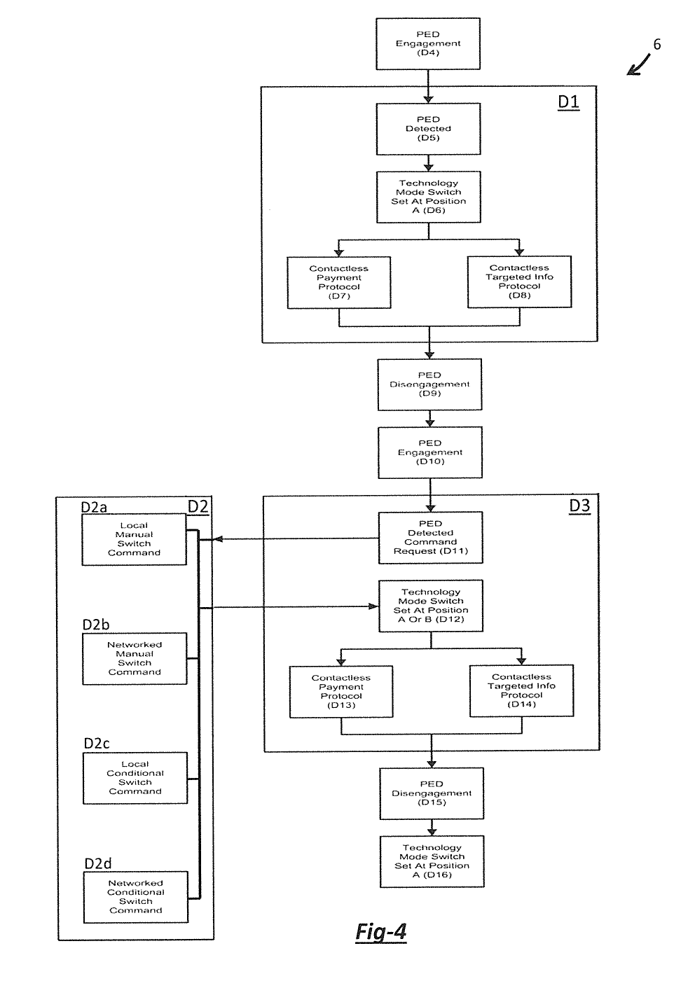

Turning now to FIG. 4, an embodiment of a mobile payment-information delivery system with a multi-engagement, multi-toggle deployment where intelligent switching selection occurs once towards the middle or end of the user's session is shown at reference numeral 6. The embodiment 6 is considered “one user interaction session achieved over multiple physical engagements” where the PED does disengage from the POS between mode switchings and where the PED used is the same device throughout the session. In this use, the system is set to one contactless protocol mode or another for the initial user engagement as desired by deployment design, then is switched between one contactless protocol mode or another for a follow-up user engagement as desired by the preferred intelligence selection. Where one user has one initial contactless protocol experience, another will have the same initial contactless protocol experience as desired by deployment design. Switch mode A might be a contactless payment protocol wherein the PUS acts as a payment gateway and switch mode B might be a contactless targeted info protocol wherein the POS acts as a distributor of information.

The system or embodiment 6 includes the PUS in a ready state Dl that is dependent upon a desired initial mode. Box D2 shows illustrative examples of preferred intelligence that may be used to control the switch's later mode and D3 shows the POS in a later ready state after successfully fulfilling its role during the initial mode. The preferred intelligence D2 can include a local manual switch command D2a, a networked manual switch command D2b, a local conditional switch command D2c and/or a networked conditional switch command D2d. A PED engages with a POS at D4 and triggers initial action from the POS. The POS detects the PED at D5 and refers to the mode switch D6 for an initial mode setting (setting A). It is appreciated that the node switch at D6 can be in a predetermined state where one mode or the other is selected in advance. Box D7 illustrates the desired initial state having been the contactless payment protocol and Box D8 shows the instance of the desired initial state having been the contactless targeted info protocol.

The PED disengages from the POS at D9 after completing a desired transaction and then re-engages with the POS at D10, presumably after a subsequent call-to-action. The POS detects the PED at D11 and sends a request to the preferred intelligence for a follow-up mode. A mode switch that is set to one of the above-mentioned protocols by the preferred intelligence is shown at D12. The selection of the contactless payment protocol by the preferred intelligence is shown at D13 and selection of the CTI protocol is shown at D14. At D15 the PED is disengaged from the POS after having completed the desired transaction and the POS is reset to the initial via the mode switch at D16.

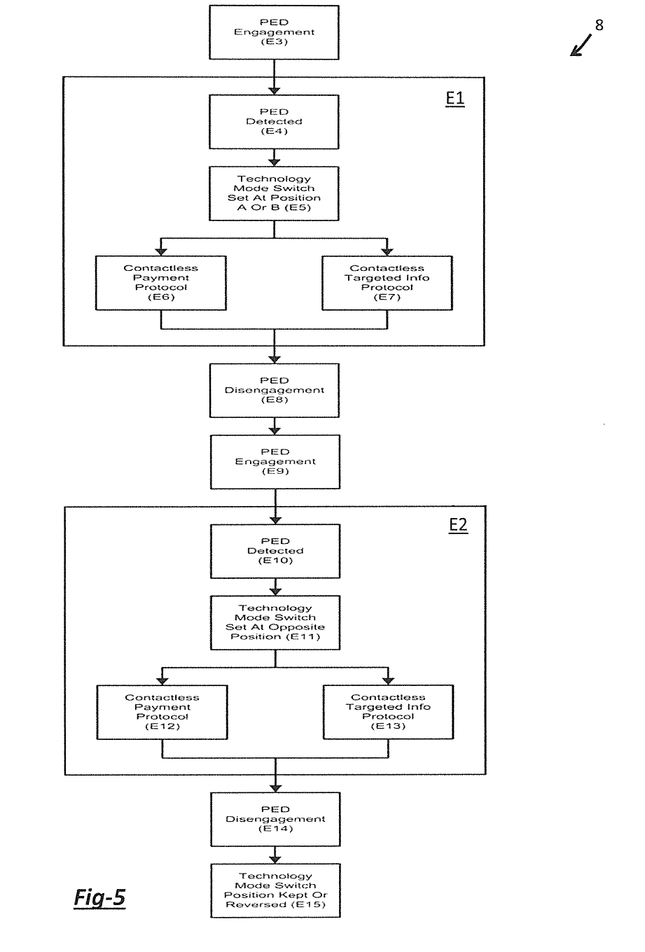

FIG. 5 illustrates an embodiment of a mobile payment-information delivery system with a multi-engagement, multi-toggle deployment where mode switching occurs without requesting preferred intelligence selection is shown at reference numeral 8. The figure better illustrated the localization possibilities of the tool and thus can be considered to demonstrate mode selection via “local intelligence.” The embodiment 8 is considered “one user interaction session achieved over multiple physical engagements” where the PED does disengage from the POS between mode switchings and where the PED used is the same device throughout the session. In this use, the system is set to one contactless protocol mode or another for the initial user engagement as desired by deployment design or the last setting from a previous session, then is switched to another contactless protocol mode for a follow-up user engagement as desired by the deployment design. Where one user has one initial contactless protocol experience, another user may have the same or different initial contactless protocol experience as desired by deployment design or the last setting from a previous session. Switch mode A might be a contactless payment protocol wherein the POS acts as a payment gateway and switch mode B might be a contactless targeted info protocol wherein the POS acts as a distributor of information.

The system or embodiment 8 includes the POS in a ready state El that is dependent upon a desired initial mode which may or may not be a mode from a previous engagement or session. Box E2 shows the POS in a later ready state after successfully fulfilling its role during the initial mode of E1. Box E3 illustrates a PED engaged with the POS, which in turn triggers initial action from the POS. At E4 the PED is detected and the POS refers to a mode switch E5 for an initial mode. The mode switch E5 can be in a predetermined state where one mode or the other is selected in advance. Box E6 shows an instance of the desired initial state having been the contactless payment protocol and Box E7 shows the instance of the desired initial state having been the contactless targeted info protocol.

The PED disengages from the POS at E8 after completing a desired transaction and then re-engages with the POS at E9, presumably after a subsequent call-to-action. The PED is detected by the POS at E10, which in turn triggers follow-up action from the POS. At E12 the reverse state of E5 is shown as the contactless payment protocol and E13 shows the reverse state of E5 being the CTI protocol. The PED is disengaged from the POS again at E14 and the POS resets the mode switch back to its desired initialized mode at E15.

The CTI and/or CTI system can be any CTI and/or CTI system known to those skilled in the art, or one or more not currently available but developed in the future. For example and for illustrative purposes only, and in no way limiting the scope of the invention, the CTI can mirror the sequence and/or timing of content (“Presentation Content”) delivered via a dynamic digital presentation system (“DPS”). In addition, the CTI system can provide editable and assignable interactive, digital content (“Interactive Presentation Content”) related to the Presentation Content. In this manner, the invention can work with multiple technologies, in multiple locations, and at multiple times for the benefit of a Consumer, manufacturer, advertiser and the like.

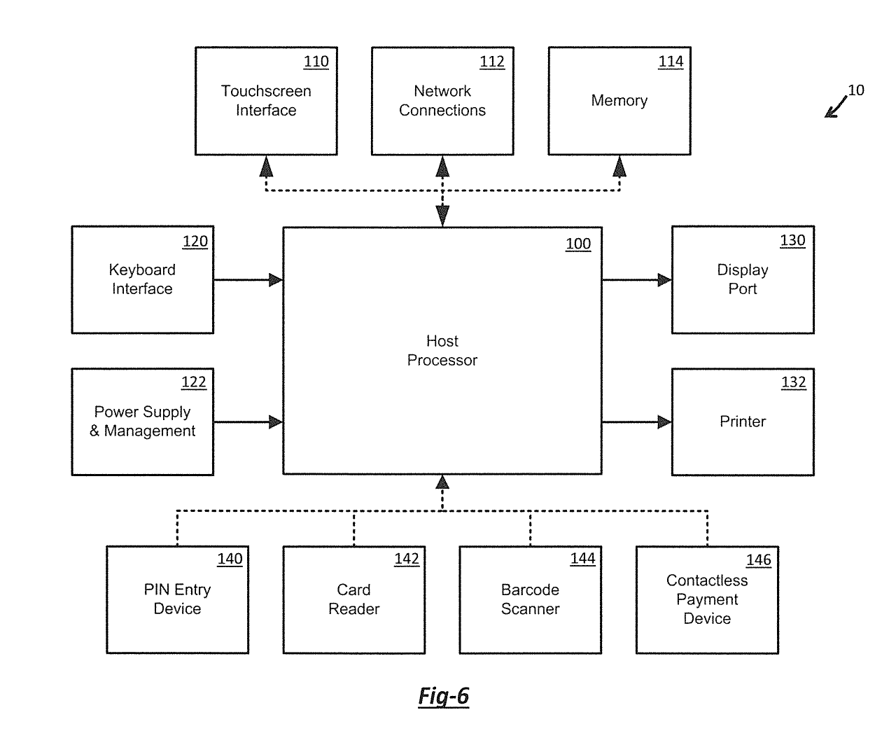

Turning now to FIG. 6, a schematic illustration of a POS device is shown generally at reference numeral 10. The POS device 10 has a host processor 100 which is electronic communication with a touchscreen interface 110, network connections 112 and memory 114. The POS device can also have a keyboard interface 120, however this is not required. A power supply and management system 122 is included, as well as a display port 130 and an optional printer 132. Regarding receiving payment for an item to be purchased, the POS device 130 can have a Personal Identification Number (PIN) entry device 140, a card reader 142, a barcode scanner 144 and a contactless payment device 146.

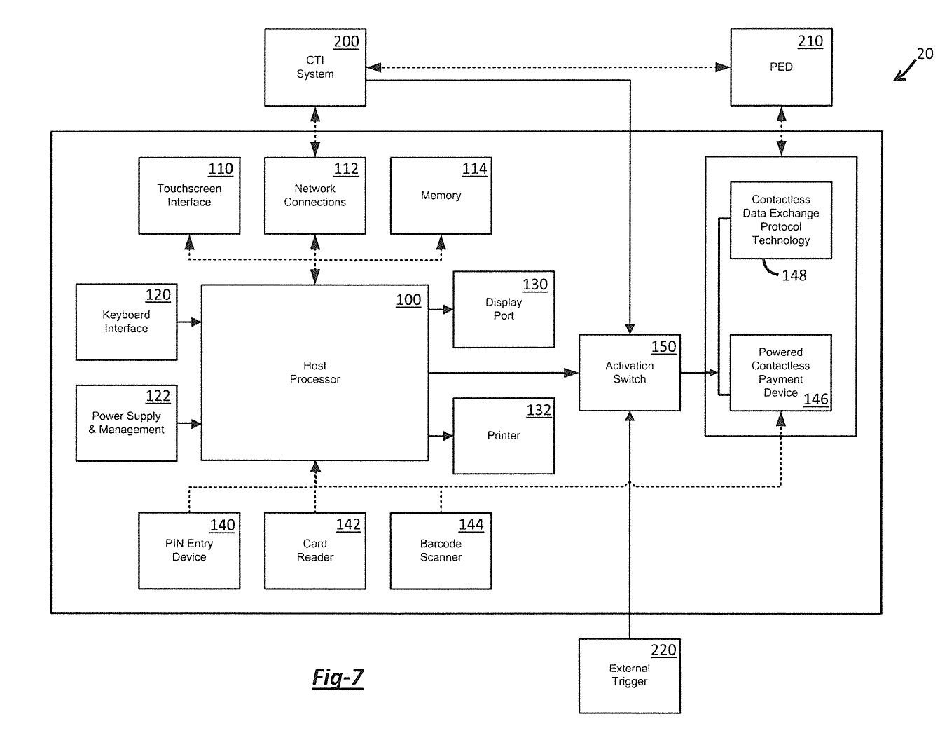

An inventive POS device with a CTI system, PED and mode switching capability is shown generally in FIG. 7 at reference numeral 20. The embodiment 20 includes the POS device 10 shown in FIG. 6 where like numerals refer to like components. In addition, a CTI system 200 is included which can provide the CTI to the POS device 10 and a PED 210 as discussed above.

An activation switch 150 is included and can be in wireless and/or wired communication with the host processor 100, an external trigger 220 and the contactless payment device 146 and a contactless CTI protocol technology device 148, e.g. an NFC tag. Based on instructions from the host processor 100, CTI system 200 and/or external trigger 220, the activation switch 150 determines which mode is active with the PED 210 during a PED-POS device exchange. Operation of the embodiment is described above with reference to FIGS. 1-5.

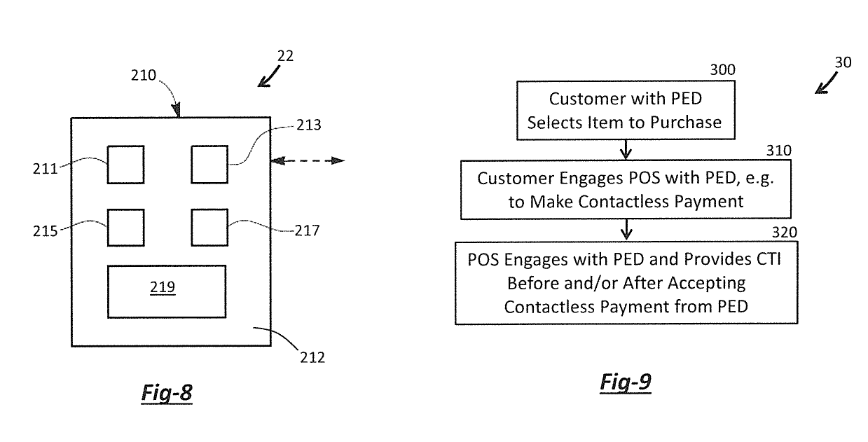

FIG. 8 provides a schematic illustration of the PED 210. The PED 210 can have one or more components as illustrated in the figure, for example a bar code scanner/reader 211, a QR code scanner or reader 213, an RFID tag reader or scanner 215, and/or an NFC tag scanner or reader 217. In addition, the PED 1210 can have a software module 219 that communicates with the components 211-217 and directs communication with a communication network. The PED 210 also has a display screen 212 which can display DPP content and CDSI content as discussed above.

It should be appreciated that the term “screen” should not be limited to known two-dimensional lighted pixel-based panels. Stated differently, advanced screens, displays, etc., that are currently known or may be developed in the future and illustratively include Google Goggles, holograms, ocular implants, braille panels and the like are included within the scope of “screen.”

A process for using the mobile payment-information delivery system disclosed herein is shown schematically in FIG. 9 at reference numeral 30. The process 30 includes a customer or a potential customer at a retail location. The customer has a PED and selects one or more items to purchase at step 300. At step 310, the customer engages a POS device with his/her PED, e.g. to purchase the selected item(s) using a contactless payment protocol such as Google Wallet, Apple Pay and the like. The PED engages the POS device and the POS device being in a desired mode interacts with the PED at step 320. For example, the POS device can be in a mobile payment portal mode or a CTI portal mode. It is appreciated that the mode selection can be set per the embodiments discussed above. In addition, after interacting with the PED in a given mode, the POS device switches to a different mode and interacts with the PED in this manner also. As such, the POS device serves a dual purpose—a portal for contactless payments and a portal for CTI delivery, and vice versa.

The invention is not to be limited to the described embodiments, examples, etc., disclosed herein. Changes, modifications, etc. to the teachings herein can be made and still fall within the scope of the invention. As such, it is the claims, and all equivalents thereof, that define the scope of the invention.

We claim:

1. A mobile payment-information delivery system comprising:
a point of sale (POS) device having a mobile payment chip and antenna, said POS device also having a first near field communication (NFC) device, said POS device with said mobile payment chip and antenna operable as a mobile payment portal, said POS device with said first near field communication (NFC) device operable as a consumer/end-user targeted information (CTI) portal; and
a portable electronic device (PED) having a second NFC device, said PED operable to make a mobile payment with said POS device operable as said mobile payment portal and receive consumer/end-user targeted information (CTI) via said POS device operable as said CTI portal.

2. The mobile payment-information delivery system of claim 1, further comprising a CTI source having CTI for delivery to said PED.

3. The mobile payment-information delivery system of claim 2, further comprising a switch configured to change said POS device from said mobile payment portal to said CTI portal and vice versa.

4. The mobile payment-information delivery system of claim 3, wherein said CTI source is part of at least one of said POS device, a local network system and a cloud-based network system.

5. The payment-information delivery system of claim 4, further comprising a dynamic digital system (DPS) configured to provide editable and assignable interactive, digital content (“Interactive Content”) related to an item purchased at said POS device via a mobile payment transaction, said CTI source being part of a said DPS.

6. The mobile payment-information delivery system of claim 5, wherein said switch is part of at least one of said POS device, a local network system and a cloud-based network system.

7. A process for making a mobile payment and information with a single point of sale device, the process comprising:
providing a point of sale (POS) device having a mobile payment chip and antenna, the POS device also having a first near field communication (NFC) device, the POS device with the mobile payment chip and antenna operable as a mobile payment portal, the POS device with the first near field communication (NFC) device operable as a consumer/end-user targeted information (CTI) portal;
providing a portable electronic device (PED) having a second NFC device, the PED operable to make a mobile payment with the POS device operable as the mobile payment portal and receive consumer/end-user targeted information (CTI) via the POS device operable as the CTI portal;
selecting an item to purchase and paying for the item with the PED and at the POS device via a mobile payment method and the POS device operating as the mobile payment portal;
switching the POS device to operate as the CTI portal; and
receiving CTI on the PED via the POS device operating as the CTI portal.

8. The process of claim 6, further including switching the POS device to operate as the mobile payment portal and paying for another item with the PED and at the POS device via a mobile payment method.

9. The process of claim 7, further including providing a CTI source having the CTI for delivery to said PED.

10. The process of claim 8, wherein the CTI source is part of at least one of the POS device, a local network system and a cloud-based network system.

11. The process of claim 9, further including providing a dynamic digital system (DPS) operable to provide editable and assignable interactive, digital content (“Interactive Content”) related to the item purchased, the CTI source being a part of the DPS.

12. The process of claim 10, further including a switch that is operable to switch the POS device from operating as the mobile payment portal to the CTI portal and vice versa.
